(19) United States
(12) Patent Application Publication
(10) Pub. No.: US 2007/0058919 A1
(43) Pub. Date: Mar. 15, 2007

(54) OPTICAL FIBER WALL OUTLET ORGANIZER SYSTEM

(76) Inventor: Raymond J. Desanti, West Boylston, MA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/532,460

(22) Filed: Sep. 15, 2006

Related U.S. Application Data
(60) Provisional application No. 60/779,025, filed on Mar. 3, 2006.
(60) Provisional application No. 60/717,302, filed on Sep. 15, 2005.

(51) Int. Cl. G02B 6/00

(52) U.S. Cl. 385/135

(57) ABSTRACT

An assembly for storing a terminal portion of an optical fiber cable, comprising a hub for receiving an optical fiber cable and having a radius sufficient to safely store an optical fiber cable; a housing adapted to receive a terminal portion of an optical fiber cable and to receive the hub; and a faceplate for substantially enclosing the housing containing the hub.

### CROSS-REFERENCES TO RELATED APPLICATIONS

This application claims the benefit of U.S. Provisional Application No. 60/779,025, filed Mar. 3, 2006, and U.S. Provisional Application No. 60/717,302, filed Sep. 15, 2005, each of which is incorporated herein by reference in its entirety.

### BACKGROUND OF THE INVENTION

Optical fiber cables are widely used in telecommunication systems to carry optical signals. For fiber-to-the-premise installations new construction, storage of the terminated fiber cable at the customer interface is required. Unlike electrical wires and cable, optical fiber cable cannot be kinked or coiled without risking damage to the optical fiber and loss of optical signal.

A need exists for a device and method for storing a terminated optical fiber cable at the customer interface. The present invention seeks to fulfill this need and provides further related advantages.

### SUMMARY OF THE INVENTION

The present invention provides an optical fiber wall outlet organizer system effective for storing and dispensing an optical fiber cable to a premise. The system includes a spooling device that can store and readily deploy an optical fiber cable. The system also includes a housing for receiving the spooling device. The system is mountable in a wall.

In one aspect, the invention provides an assembly for storing a terminal portion of an optical fiber cable. The assembly includes a hub for receiving an optical fiber cable and having a radius sufficient to safely store an optical fiber cable; a housing adapted to receive a terminal portion of an optical fiber cable and to receive the hub; and a faceplate for substantially enclosing the housing containing the hub.

In the assembly, the hub radius is greater than the minimum bend radius of an optical fiber terminated in the housing. In one embodiment, the minimum bend radius is about 1.5 inches. In one embodiment, the hub includes a pair of posts for retaining optical fiber cable at a radius greater than its minimum bend radius. In one embodiment, the hub includes a splice sleeve holder.

In the assembly, the faceplate includes an adapter for connecting an optical fiber cable terminated in the assembly to a second cable for communicating optical signal from the optical fiber cable terminated in the assembly to the second cable.

In another aspect, the invention provides an assembly for storing a terminal portion of an optical fiber cable. The assembly includes a terminal portion of an optical fiber cable, wherein the cable terminates with a connector; a hub for receiving the optical fiber cable and having a radius sufficient to safely store the optical fiber cable, wherein a portion of the optical fiber is coiled about/within the hub; a housing having an aperture for receiving the terminal portion of an optical fiber cable and adapted for receiving the hub; and a faceplate for substantially enclosing the housing containing the hub and terminal portion of the optical fiber cable, wherein the faceplate comprises an adapter for receiving the connector of the optical fiber terminated in the housing and for receiving a connector of a second cable, wherein the adapter communicates optical signal from the optical fiber cable terminated in the assembly to the second cable.

In the assembly, the hub radius is greater than the minimum bend radius of an optical fiber terminated in the housing. In one embodiment, the minimum bend radius is about 1.5 inches. In one embodiment, the hub includes a pair of posts for retaining optical fiber cable at a radius greater than its minimum bend radius. In one embodiment, the hub includes a splice sleeve holder.

In a further aspect of the invention, a kit is provided. The kit includes a hub having an aperture to receive an optical fiber cable and having a radius sufficient to safely store an optical fiber cable; and a housing having an aperture to receive a terminal portion of an optical fiber cable and adapted to receive the hub.

In the kit, the hub radius is greater than the minimum bend radius of an optical fiber terminated in the housing. In one embodiment, the minimum bend radius is about 1.5 inches. In one embodiment, the hub includes a pair of posts for retaining optical fiber cable at a radius greater than its minimum bend radius. In one embodiment, the hub includes a splice sleeve holder. In one embodiment, the housing is an outlet box.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a perspective view of a representative assembly of the invention including housing and hub for receiving and safely storing the terminal portion of an optical fiber cable, and housing faceplate with adapter;

FIG. 1B is an exploded view of a representative assembly of the invention including housing, hub, and faceplate, and illustrating the hub removed from the housing and a portion of an optical fiber cable removed from the hub; and

FIG. 2 is a perspective view of a representative hub useful in the assembly and kit of the invention.

### DETAILED DESCRIPTION OF THE PREFERRED EMBODIMENT

The present invention provides an optical fiber wall outlet organizer system that includes a spooling device (or hub) for an optical fiber cable. The spooling device dispenses and stores an optical fiber cable without damage to the optical fiber. The organizing system also includes a housing for receiving the spool (or hub). The housing is mountable in a wall

In one aspect, the invention provides an assembly for storing a terminal portion of an optical fiber cable. In one embodiment, the assembly includes a hub for receiving an optical fiber cable and having a radius sufficient to safely store an optical fiber cable; a housing adapted to receive a terminal portion of an optical fiber cable and to receive the hub; and a faceplate for substantially enclosing the housing containing the hub.

In the assembly, the faceplate includes an adapter for connecting an optical fiber cable terminated in the assembly to a second cable for communicating optical signal from the optical fiber cable terminated in the assembly to the second cable.

In another aspect, the invention provides an assembly for storing a terminal portion of an optical fiber cable. The assembly includes a terminal portion of an optical fiber cable, wherein the cable terminates with a connector; a hub for receiving the optical fiber cable and having a radius sufficient to safely store the optical fiber cable, wherein a portion of the optical fiber is coiled about/within the hub; a housing having an aperture for receiving the terminal portion of an optical fiber cable and adapted for receiving the hub; and a faceplate for substantially enclosing the housing containing the hub and terminal portion of the optical fiber cable. The faceplate comprises an adapter for receiving the connector of the optical fiber terminated in the housing and for receiving a connector of a second cable, and the adapter communicates optical signal from the optical fiber cable terminated in the assembly to the second cable.

For these assemblies, the hub radius is greater than the minimum bend radius of an optical fiber terminated in the housing. In one embodiment, the minimum bend radius is about 1.5 inches. In one embodiment, the hub includes a pair of posts for retaining optical fiber cable at a radius greater than its minimum bend radius. In one embodiment, the hub includes a splice sleeve holder.

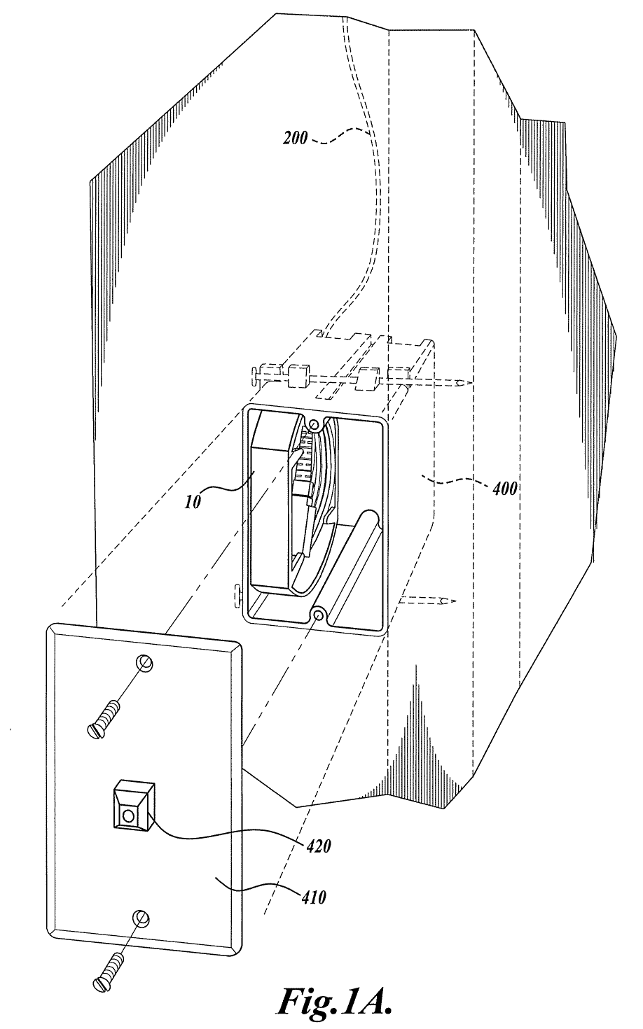

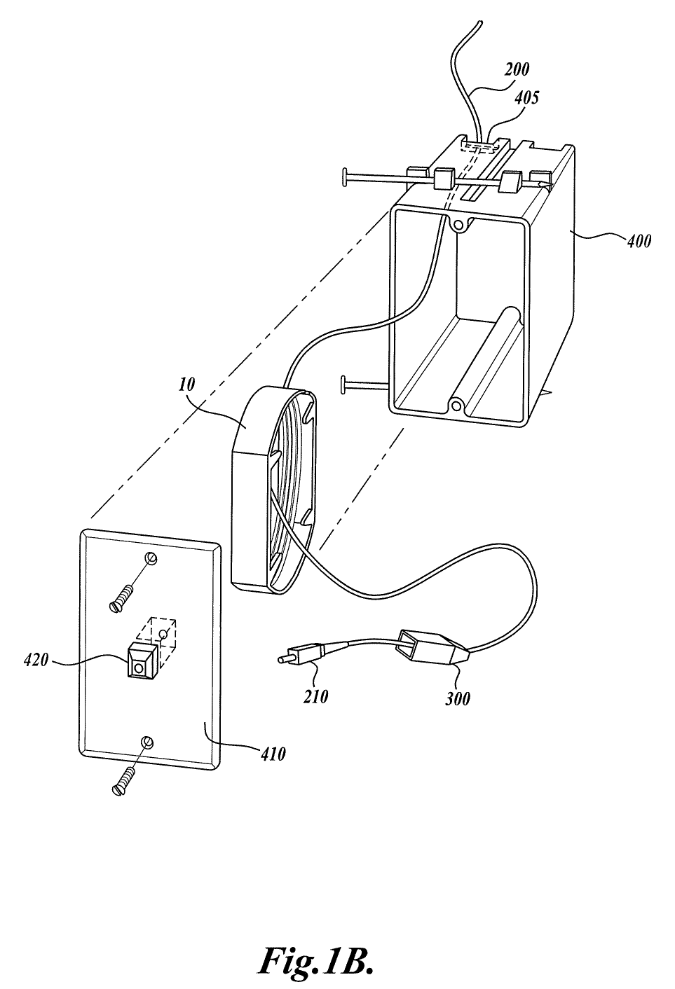

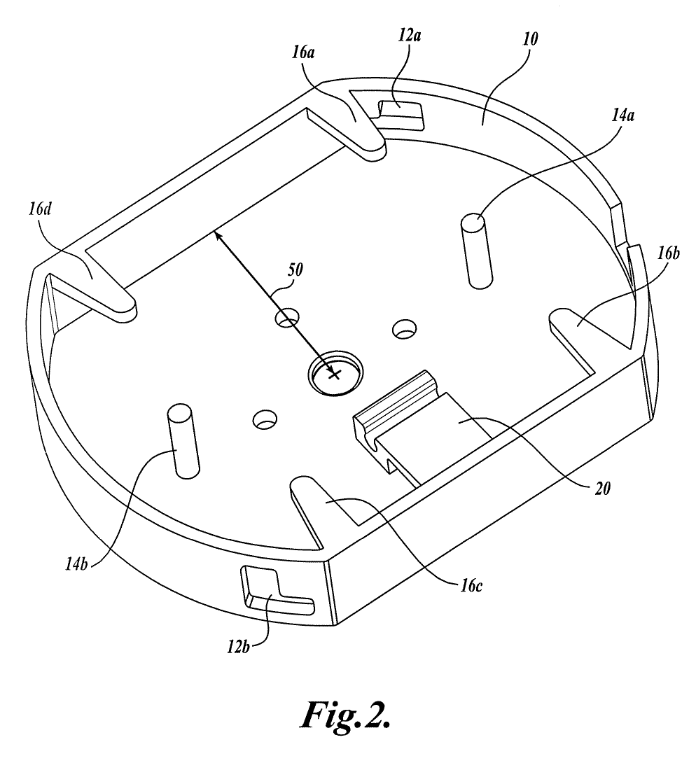

Representative assemblies of the invention are illustrated in FIGS. 1A and 1B. A representative hub is illustrated in FIG. 2.

FIG. 1A is a perspective view of a representative assembly of the invention including housing and hub for receiving and safely storing the terminal portion of an optical fiber cable, and housing faceplate with adapter. FIG. 1A illustrates the terminal portion of the optical fiber cable stored within the hub stored within its housing. FIG. 1A illustrates the housing mounted in a wall: housing 400 (outlet box) is nailed to a wooden post or stud. FIG. 1B is an exploded view of a representative assembly of the invention including housing, hub, and faceplate. FIG. 1B illustrates the hub removed from its housing and a portion of the optical fiber cable removed from the hub.

Referring to FIGS. 1A and 1B, the terminal portion of optical fiber cable 200 terminates with connector 210 (see FIG. 1B). Hub 10 receives optical fiber cable 200 and has a radius sufficient to safely store the optical fiber cable. FIGS. 1A and 1B illustrate a portion of the optical fiber coiled within the hub. Hub 10 is received in housing 400 having aperture 405 (see FIG. 1B) for receiving the terminal portion of optical fiber cable 200. Faceplate 410 substantially encloses the housing containing the hub and terminal portion of the optical fiber cable. Faceplate 410 includes adapter 420 for receiving the connector (210) of the optical fiber terminated in the housing and for receiving a connector of a second cable (not shown). The adapter communicates optical signal from the optical fiber cable terminated in the assembly to the second cable. In one embodiment, the connection between optical fiber connector 210 and the adapter is protected by slidable boot 300 (see FIG. 1B) that protects the optical fiber connection from the environment including dust that can be damaging to an optical fiber connection.

FIG. 2 is a perspective view of a representative hub of the assembly and kit of the invention. Referring to FIG. 2, hub 10 having radius 50 includes at least one aperture for receiving a terminal portion of an optical fiber cable. In one embodiment, the hub includes one aperture (i.e., 12a) and, in another embodiment, the hub includes two apertures (i.e., 12a and 12b). In one embodiment, hub 10 includes posts 14a and 14b for retaining optical fiber cable at a radius greater than its minimum bend radius. In one embodiment, hub 10 includes optical fiber cable retention tabs for retaining stored cable in the hub. Retention tabs 16a-16d are illustrated in FIG. 2. In one embodiment, the hub includes splice sleeve holder 20.

As noted above, faceplate 410 includes an adapter for connecting the optical fiber cable that terminates in the outlet box with the optical fiber cable within the premise for communication with devices in the premise receiving optical fiber signal. The adapter receives connectors from each of the optical fiber cables (i.e., the cable terminating in the box and the cable servicing the premise devices) and serves as a connection of the two optical fiber cables.

In a further aspect of the invention, a kit is provided. The kit includes a hub (as described above) having an aperture to receive an optical fiber cable and having a radius sufficient to safely store an optical fiber cable (see, for example, hub 10 in FIG. 2); and a housing (as described above) having an aperture to receive a terminal portion of an optical fiber cable and adapted to receive the hub (see, for example, housing 400 in FIGS. 1A and 1B). The hub radius is greater than the minimum bend radius of an optical fiber terminated in the housing. In one embodiment, the minimum bend radius is about 1.5 inches. In one embodiment, the hub includes a pair of posts for retaining optical fiber cable at a radius greater than its minimum bend radius. In one embodiment, the hub includes a splice sleeve holder. In one embodiment, the housing is an outlet box.

The optical fiber wall outlet organizer system of the present invention is a slack fiber organizer and splice organizer that is useful in fiber-to-the-premises (FTTP) installations new construction where storage of terminated fiber cable at the customer interface is required. In one embodiment, the optical fiber wall outlet organizer system can store up to about three feet of 3-millimeter cable or jumper. In one embodiment, the organizer can store up to about one meter of fiber pigtail (900 μm) and splice at the customer premise. The organizer system of the invention requires no wire ties or clamps and has a hub having a bend radius sufficient to safely store optical fiber cable without damaging the fiber by bending beyond its minimum bend radius.

While illustrative embodiments have been illustrated and described, it will be appreciated that various changes can be made therein without departing from the spirit and scope of the invention.

The embodiments of the invention in which an exclusive property or privilege is claimed are defined as follows:

1. An assembly for storing a terminal portion of an optical fiber cable, comprising:
(a) a hub for receiving an optical fiber cable and having a radius sufficient to safely store an optical fiber cable;
(b) a housing adapted to receive a terminal portion of an optical fiber cable and to receive the hub; and
(c) a faceplate for substantially enclosing the housing containing the hub.

2. The assembly of claim 1, wherein radius is greater than the minimum bend radius of an optical fiber terminated in the housing.

3. The assembly of claim 2, wherein the minimum bend radius is about 1.5 inches.

4. The assembly of claim 1, wherein the faceplate comprises an adapter for connecting an optical fiber cable terminated in the assembly to a second cable for communicating optical signal from the optical fiber cable terminated in the assembly to the second cable.

5. The assembly of claim 1, wherein the hub comprises a pair of posts for retaining optical fiber cable at a radius greater than its minimum bend radius.

6. The assembly of claim 1, wherein the hub comprises a splice sleeve holder.

7. An assembly for storing a terminal portion of an optical fiber cable, comprising:
(a) a terminal portion of an optical fiber cable, wherein the cable terminates with a connector;
(b) a hub for receiving the optical fiber cable and having a radius sufficient to safely store the optical fiber cable, wherein a portion of the optical fiber is coiled about the hub;
(c) a housing having an aperture for receiving the terminal portion of an optical fiber cable and adapted for receiving the hub; and
(d) a faceplate for substantially enclosing the housing containing the hub and terminal portion of the optical fiber cable, wherein the faceplate comprises an adapter for receiving the connector of the optical fiber terminated in the housing and for receiving a connector of a second cable, wherein the adapter communicates optical signal from the optical fiber cable terminated in the assembly to the second cable.

8. The assembly of claim 7, wherein radius is greater than the minimum bend radius of the optical fiber terminated in the housing.

9. The assembly of claim 8, wherein the minimum bend radius is about 1.5 inches.

10. The assembly of claim 7, wherein the hub comprises a pair of posts for retaining optical fiber cable at a radius greater than its minimum bend radius.

11. The assembly of claim 7, wherein the hub comprises a splice sleeve holder.

12. A kit, comprising:
(a) a hub having an aperture to receive an optical fiber cable and having a radius sufficient to safely store an optical fiber cable; and
(b) a housing having an aperture to receive a terminal portion of an optical fiber cable and adapted to receive the hub.

13. The kit of claim 12, wherein radius is greater than the minimum bend radius of an optical fiber terminated in the housing.

14. The kit of claim 13, wherein the minimum bend radius is about 1.5 inches.

15. The kit of claim 12, wherein the hub comprises a one or more posts for retaining optical fiber cable at a radius greater than its minimum bend radius.

16. The kit of claim 12, wherein the hub comprises one or more tabs for retaining optical fiber cable within the hub.

17. The kit of claim 12, wherein the hub comprises a splice sleeve holder.
